(19) United States
(12) Patent Application Publication
(10) Pub. No.: US 2006/0112810 A1
(43) Pub. Date: Jun. 1, 2006

(54) Ordering audio signals

(76) Inventors: David A Eves, Crawley (GB); Christopher Thorne, East Croydon (GB)

Correspondence Address: PHILIPS INTELLECTUAL PROPERTY & STANDARDS, P.O. BOX 3001, BRIARCLIFF MANOR, NY, 10510, US

(21) Appl. No.: 10/537,126

(22) PCT Filed: Dec. 10, 2003
(86) PCT No.: PCT/IB03/05961

§ 371 Date: Jun. 2, 2005

(51) Int. Cl. G10H 7/00; A63H 5/00; G04B 13/00

(52) U.S. Cl. 84/609

(57) ABSTRACT

A method for ordering a plurality of audio signals into a sequence comprising receiving (104) a user preference, analysing (108) the plurality of audio signals to extract inherent features and ordering (110), independently of user involvement, start into a sequence at least two of the plurality of audio signals based on a comparison of the extracted features and user preference such that adjacent signals in the sequence are harmonious. The plurality of audio signals may be identified (106) according to the user preference. The ordered audio signals may be outputted (112).

The present invention relates to a method and system for ordering a plurality of audio signals, in particular the ordering of music tracks.

Consider audio signals comprising music tracks. Typically a consumer wishes to select a set of tracks and order these into a suitable listening sequence. Traditionally both these tasks have been handled by the music distributors or artists, for example by providing a set of tracks on an album (vinyl record, audio CD or the like) ordered into a predetermined play sequence. New distribution models (for example Internet downloading) and storage models (including the ability to randomly access music tracks stored as digital files) have migrated the tasks of selection and arrangement a way from distributor or artist to the end user. At one level, an arbitrary sequencing of selected tracks is possible, for example using the shuffle (randomised) play feature of CD players. An advantage of this technique is its ease of use (single button press) to generate a sequence different from the predetermined play sequence; however, the resulting sequence is arbitrary. Some CD players employ means to select and order tracks. This allows a customised sequence to be determined by the user at the cost of more time and effort. More recently, products such as digital music jukeboxes allow a user to assemble a library of perhaps hundreds of tracks representing the overall taste(s) of the user. The issue of selecting a set of tracks to play from potentially many tracks arises. Various techniques are available to select such a set, ranging from the user manually picking tracks to automatic selection, for example using classification (artist, title, genre, or similar). However, a disadvantage remains in that a suitable ordering of the tracks (also termed ‘playlist’) must be undertaken; not only does this is require time and effort from the user, but also skill to achieve an ordering which matches the user's preference.

European Patent application EP1162621 to Hewlett Packard discloses a method of automatically determining the sequence of a set of songs according to their rate of repeat of the dominant beat (the tempo) and an ideal temporal map for the resulting compilation and that end portions of adjacent songs overlap. A disadvantage of this method is that compatibility of adjacent songs in the sequence is not explicitly addressed which, for a given sequence, can result in a dissonant transition between adjacent songs, especially in situations where adjacent songs are overlapped.

It is an object of the invention to improve on the known art.

In accordance with the present invention there is provided a method for ordering a plurality of audio signals into a sequence comprising:

receiving a user preference;

analysing the plurality of audio signals to extract inherent features; and

ordering, independently of user involvement, into a sequence at least two audio signals of the plurality of audio signals based on a comparison of the extracted features and user preference such that adjacent signals in the sequence are harmonious.

According to a further aspect there is provided a system for ordering a plurality of audio signals into a sequence comprising:

a receiving device operable to receive a user preference;

a store operable to store audio signals;

a data processor operable to:
analyse the plurality of audio signals to extract inherent features; and
order, independently of user involvement, into a sequence at least two audio signals of the plurality of audio signals based on a comparison of the extracted features and user preference such that adjacent signals in the sequence are harmonious.

Owing to the invention it is possible to order audio signals into a sequence independently of user involvement. The audio signals may be analogue or digital.

Advantageously, the plurality of audio signals is identified according to the user preference. Suitably, the extracted inherent features are musical features, including musical key and bass note amplitude. Preferably, adjacent audio signals in the sequence have related musical keys. Ideally, the related musical keys are determined according to the Equal Tempered Scale.

Optionally, the method outputs the at least two audio signals according to the sequence, for example as an audio presentation to a user. Advantageously, a currently output signal is crossfaded with the immediately succeeding signal in the sequence so as to present a continuous outputting. Suitably, crossfading is performed dependent on the respective bass note amplitudes of the current signal and the immediately succeeding signal in the sequence. Preferably, during the time interval of the crossfade the bass note amplitude of each audio signal is less than one seventh of the maximum bass amplitude of the respective audio signal.

An advantage of the present invention is that there is a harmonious transition between adjacent audio signals of a sequence, even when portions of adjacent audio signals overlap. Furthermore, the sequence is able to be generated with minimum effort from a user, for example the user simply selecting a mode or genre style by means of a simple interface to put together ordered collections of audio signals for events e.g. for a party or romantic evening. Whilst retaining harmonious transitions, the invention can also order the audio signals according to an overall profile of the sequence, for example by selecting tracks according to musical keys thereby allowing suitable key transitions to be traversed during the sequence.

Embodiments of the invention will now be described, by way of example only, with reference to the accompanying drawings in which:

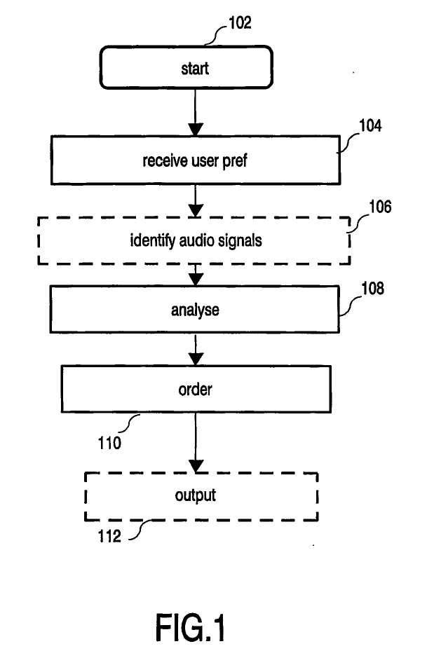

FIG. 1 is a flow diagram of a method for ordering a plurality of audio signals into a sequence;

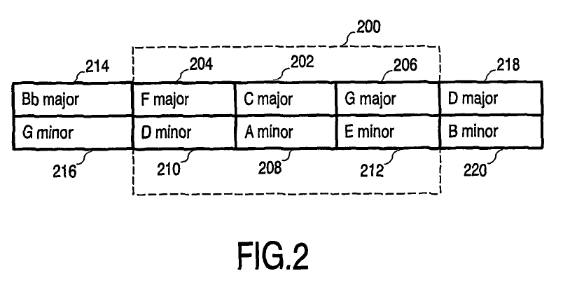

FIG. 2 is a schematic representation of an exemplary set of related musical keys for use in the method of FIG. 1;

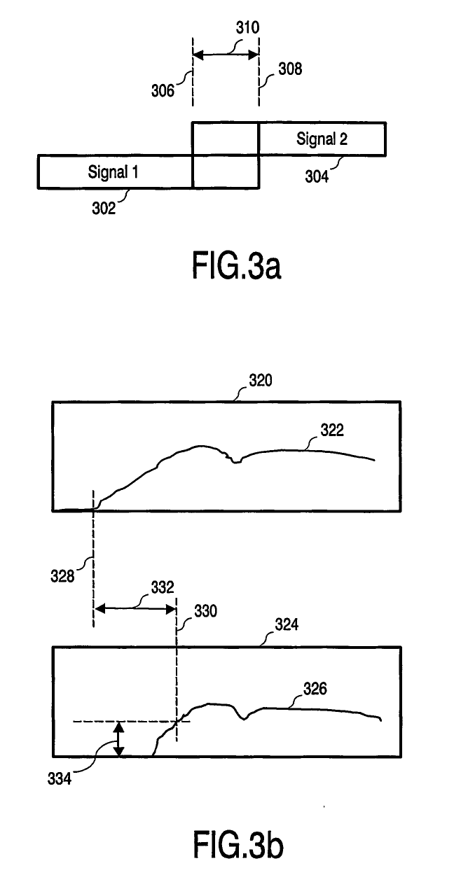

FIG. 3a is a schematic representation of a currently output signal crossfaded with its immediately succeeding signal in a sequence;

FIG. 3b is a schematic representation of the determination of a crossfade interval for an audio signal;

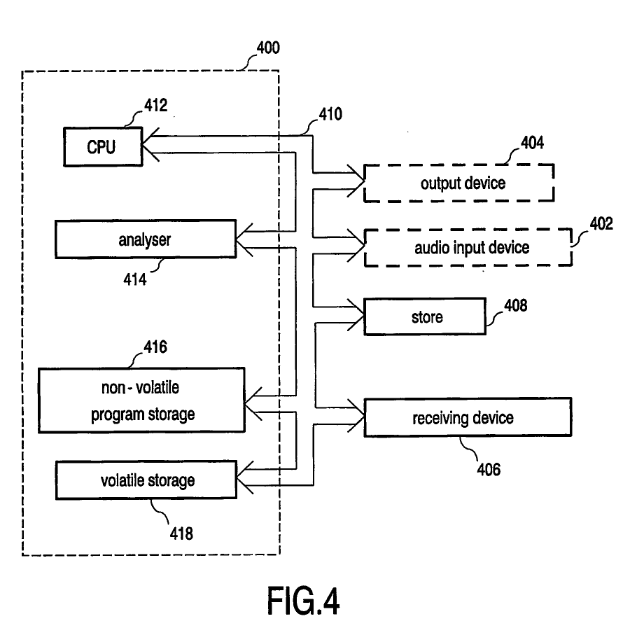

FIG. 4 is a schematic representation of a system for ordering a plurality of audio signals into a sequence;

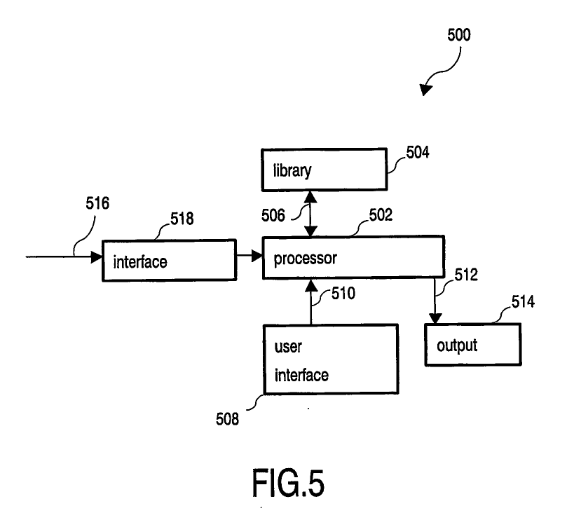

FIG. 5 is a schematic representation of a first application of the system of FIG. 4 for ordering a plurality of audio signals into a sequence implemented as a digital music jukebox; and

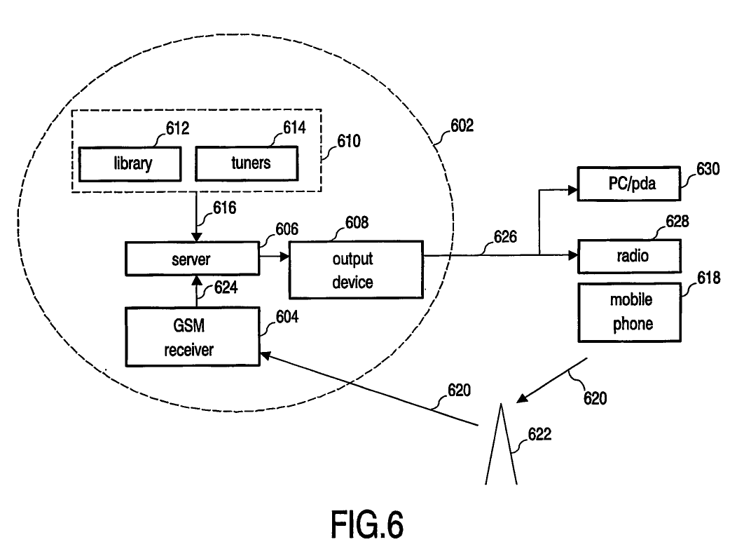

FIG. 6 is a schematic representation of a second application of the system of FIG. 4 for ordering a plurality of audio signals into a sequence implemented by a network service provider.

The term ‘harmonious’ as used herein means that sufficient compatibility exists between adjacent audio signals of a sequence such that the transition between adjacent audio signals is not dissonant. Suitably, the similarity of certain features contained within adjacent audio signals contributes to harmoniousness; examples of such features include pitch, level and rate of delivery.

FIG. 1 shows a flow diagram of a method for ordering a plurality of audio signals into a sequence. The method commences at 102 and a user preference is received 104. The plurality of audio signals may be all audio signals that are presently available to the method via for example storage, a network entity such as a server, and the like. Optionally (as denoted by the dashed outline) the plurality of audio signals is identified 106 to be a subset of the audio signals that are presently available. The subset may be identified according to classification including for example genre, artist, title and the like. Preferably, the plurality of signals is identified according to the user preference. The user may manually identify the plurality of audio signals; preferably, the identification is performed automatically according to the user preference thereby reducing time and effort. Any suitable automated identification may be used, for example selecting one or more classifications according to the user preference and identifying the plurality of audio signals based on the selected classification(s). In UK patent application 0303970.8 (PHGB030014) by the present applicant, a method is disclosed which identifies an audio signal from a set of audio signals. The audio signals are analysed to extract features. Audio signals are then identified based on a comparison of the user preference and extracted features.

Following identification of the plurality of audio signals, the method then analyses 108 the plurality of audio signals to extract inherent features. Any audio signal may comprise one or more features which are intrinsically attached or connected to the audio signal. Such features are herein termed ‘inherent’ and are distinguished from, for example, metadata associated with an audio signal, since such metadata is separate from its associated audio signal. Inherent features of audio signals include musical features. In particular, the method extracts and utilises musical features comprising musical key, musical tempo and bass note amplitude, as further discussed below. The method then continues by ordering 110 into a sequence at least two audio signals of the plurality of audio signals based on a comparison of the extracted features and user preference such that adjacent signals in the sequence are harmonious. In any particular example the resulting sequence may comprise all the identified plurality of audio signals or only a subset of these, dependent on the correspondence between the extracted features and those features representing the user preference. The user preference can comprise any information suitable for use in comparison with the extracted features of the audio signals. Examples of such information include, in any combination, a representative audio signal; the indication of a mood, genre, artist or the like; an overall profile for the sequence.

Within a sequence, adjacent audio signals are harmonious. For musical audio signals, harmonious means that the values of corresponding types of features present in adjacent audio signals must be musically compatible. An example is where the respective musical key of each adjacent audio signal is related. In UK application 0229940.2 (PHGB020248) by the present applicant a method is disclosed for determining the key of an audio signal such as a music track. Portions of the audio signal are analysed to identify a musical note and its associated strength within each portion. A first note is then determined from the identified musical notes as a function of their respective strengths. From the identified musical notes, at least two further notes are selected as a function of the first note. The key of the audio signal is then determined based on a comparison of the respective strengths of the selected notes. Once the sequence of audio signals has been determined the method optionally (as denoted by the dashed outline) outputs 112 the at least two audio signals according to the sequence.

FIG. 2 shows a schematic representation of an exemplary set of related musical keys for use in the method of FIG. 1. In the case where audio signals ordered into a sequence using the method of FIG. 1 comprise musical content, preferably the ordering of the audio signals is arranged so that adjacent audio signals of the sequence are harmonious such that their respective musical keys are related. Ideally, related musical keys are determined according to the Equal Tempered Scale common to the majority of Western music. FIG. 2 shows some of the keys of the Equal Tempered Scale. Major keys are represented in the row comprising 214, 204, 202, 206, 218; minor keys are represented in the row comprising 216, 210, 208, 212, 220.

Consider an audio signal within a particular sequence of audio signals is a music track in the key of C major. In FIG. 2, dashed outline 200 encompasses all keys of the Equal Tempered Scale which are determined by music theory to be closely related to the key of C major 202. Presuming an adjacent audio signal to the C major signal is a music track, then preferably this adjacent signal is in the same or a closely related key which, in this example, comprises any one of the keys encompassed in the dashed outline 200: F major 204, C major 202, G major 206, D minor 210, A minor 208 or E minor 212. Suppose, the adjacent signal has the key D minor 210, then the key of the next adjacent audio signal to the D minor signal (again presuming this next signal is a music track) is the same, or is closely related, and thus is in any one of the keys: G minor 216, D minor 210, A minor 208, Bb major 214, F major 204 or C major 202. In addition to related musical keys, other features may be used to ensure adjacent signals in a sequence are harmonious, for example musical tempo and bass note amplitude.

FIG. 3a shows a schematic representation of a currently output signal crossfaded with its immediately succeeding signal in a sequence. Crossfading permits a continuous outputting of audio signals by overlapping adjacent audio signals of an outputted sequence for a period of time during which the signals are mixed. First audio signal 302 and second audio signal 304 are successive signals in a sequence. When first audio signal 302 is output, at some point in time 306 a crossfade with the second audio signal 304 commences which then completes at a later time 308, such that after this time only the second audio signal 304 is output; the duration of the crossfade is shown at 310. The crossfading may be performed dependent on the respective bass note amplitudes of the current signal and the immediately succeeding signal in the sequence. This is because when the tempos of these signals are not matched, crossfading preferably takes place during a period when both signals have no significant bass amplitude, suitably when the bass amplitude of each audio signal is less than one seventh of the maximum bass amplitude of the respective audio signal.

FIG. 3b shows a schematic representation of a determination of a crossfade interval for an audio signal. The ‘crossfade interval’ is a time interval within an audio signal during (all or part of) which a crossfade with another suitable signal is preferably performed. Typically, an audio signal would have at least two such intervals, one residing substantially at the beginning and the other substantially at the end of the signal; crossfade intervals may also be identifiable elsewhere in the signal. FIG. 3b shows the determination of the crossfade interval of an audio signal according to the bass note amplitude of the audio signal. Boxes 320, 324 each depict (not to scale) amplitude response curves 322, 326 of the audio signal. Curve 322 represents a plot against time (on the horizontal axis) of maximum amplitudes for a range of audio frequencies within the audio signal, for example 50-20,000 Hz. Curve 326 represents a plot against time of maximum amplitudes for a sub-range of audio frequencies, for example the bass frequencies 50-600 Hz. Time point 328 denotes the start of the audible part of the audio signal, this being the point at which amplitude rises above zero. Time point 330 denotes the start of significant bass content in the audible part of the audio signal, this being the point at which base amplitude is greater than a predetermined amount 334 of the maximum bass amplitude of the audio signal. It has been found that a suitable predetermined amount 334 for an audio signal is one seventh of its maximum bass amplitude. The time interval 332 (between points 328 and 330) represents the maximum interval within which a crossfade can occur (in this depicted example, during the beginning portion of the audio signal). Given any two suitable audio signals, one or more such intervals in each of the signals may be determined during which crossfading between them is possible.

FIG. 4 shows a schematic representation of a system for ordering a plurality of audio signals into a sequence. The system comprises a data processor 400, a receiving device 406 and a store 408 all interconnected via data and communications bus 410. Optionally (as depicted by the dashed outlines in FIG. 4) the system also comprises an audio input device 402 and an output device 404; these also being connected to bus 410. The data processor comprises a CPU 412 running under control of software program held in non-volatile program storage 416 and using volatile storage 418 to hold temporary results of program execution. The data processor also comprises an audio signal analyser 414 which is used to analyse audio signals to extract features; alternatively, this function may be performed by the CPU under software control. The store 408 typically stores many audio signals, for example the entire musical library of a user. All, or a portion (subset) comprising a plurality, of the audio signals held in the store are analysed; the identification of the plurality of stored audio signals to be analysed may be determined by the data processor 400 according to the user preference, as discussed earlier. Of those audio signals analysed, two or more may then be subsequently ordered, independently of user involvement, into a sequence based on a comparison of the extracted features and user preference such that adjacent signals in the sequence are harmonious. The receiving device 406 is any suitable device able to receive a user preference; examples include a user interface and a network interface. The latter may be wired or wireless (an example of which is described in relation to FIG. 6 below). The user preference itself may range from a simple invocation to a more complex preference which for example specifies a mood, theme and/or the identity of the plurality of audio signals to be analysed. Optionally, the audio input device 402 is used to receive audio signals which the data processor 400 then arranges to store in store 408. Examples of suitable audio input devices capable to receive audio signals include broadcast radio tuners (e.g. AM, FM, cable, satellite), Internet access devices (e.g. Internet browser means within a PC), wired or wireless network interfaces (e.g. to access computer networks and the Internet) and modems (e.g. cable, dial-up, broadband, etc.). Also optionally, an output device 404 is provided in the system which then outputs the at least two audio signals of the plurality of audio signals according to the sequence, under control of the data processor 400. The output signals may be in analogue or digital formats. Preferably, the output device 404 is able to crossfade a currently output signal with the immediately succeeding signal in the sequence. Alternatively, the functions of the output device may be performed by the data processor 400.

FIG. 5 shows a schematic representation of a first application of the system of FIG. 4 for ordering a plurality of audio signals into a sequence implemented as a digital music jukebox, shown generally at 500. The jukebox comprises a processor 502 which receives a user preference 510 from user interface 508. The user interface might allow a user to input a user preference by means of a single press on a keypad, for example to select a preset genre type such as ‘party’, ‘romantic’ or some other pre-determined preference. Such a user interface allows ease of use and compact implementation in portable products. In response to a received user preference, the processor 502 then reads audio signals 506 from library 504, performs analysis and ordering as discussed earlier and outputs audio signals 512 to output device 514 which performs crossfading of the audio signals under control of the processor 502. Interface 518, acting as an audio signal input device, can be used to receive further audio signals from sources external to the jukebox, for example from an external PC or tuner. Examples of suitable interfaces include wired interfaces such as RS232, Ethernet, USB, FireWire, S/PDIF, and wireless interfaces such as IrDA, Bluetooth, ZigBee, IEEE802.11, HiperLAN. Audio signals may be analogue or digital. Examples of suitable digital audio signal formats include AES/EBU, CD audio, WAV, AIFF and MP3. The determination of more sophisticated user preferences is also possible by utilising a user interface of another product, such as a PC, connectable via interface 518 to the jukebox 500; the user preference may then be loaded into the jukebox using this interface, acting in this case as a receiving device. Content 516 carried over the interface may therefore comprise audio signals and/or a user preference. Furthermore, interface 518 may be implemented by means of one or more interface types as described above, such as a combination of IrDA (e.g. to convey the user preference) and analogue audio; alternatively, a single interface (e.g. USB) can support the transfer of audio signals and user preferences from an external system to the jukebox.

FIG. 6 shows a schematic representation of a second application of the system of FIG. 4 for ordering a plurality of audio signals into a sequence implemented by a network service provider. The system 602, in response to a user preference 624, is able to read audio signals 616 from an audio input device 610 (consisting of an audio signals library 612, and tuners 614 operable to receive audio signals from sources via broadcast and network delivery means described earlier). A server 606 analyses and orders the audio signals and forwards these to output device 608 which performs crossfading of the audio signals under control of the server 606 and converts the output signal to a format (for example, HTTP over TCP/IP, or RF modulation) suitable for transfer to, and receipt by, end user equipment such as a PC/pda 630 or radio 628. In this way a service provider can generate and output an ordered sequence of audio signals 626 according to an user preference 624. Such a user preference may be individual or an aggregate preference derived by the service provider from a set of received individual preferences; this latter scenario is especially useful in cases where there is limited bandwidth available to deliver the sequence of audio signals to end users, e.g. via radio broadcast. In the example, a user determines a preference using a mobile phone 618; the preference is then forwarded as an SMS message 620 via GSM network 622. The service provider receives the SMS message using GSM receiver 604; after decoding the SMS message by the GSM receiver, the user preference 624 is forwarded to the server 606.

The foregoing method and implementation are presented by way of example only and represent a selection of a range of methods and implementations that can readily be identified by a person skilled in the art to exploit the advantages of the present invention.

In the description above and with reference to FIG. 1 there is disclosed a method for ordering a plurality of audio signals into a sequence comprising receiving 104 a user preference, analysing 108 the plurality of audio signals to extract inherent features and ordering 110, independently of user involvement, into a sequence at least two of the plurality of audio signals based on a comparison of the extracted features and user preference such that adjacent signals in the sequence are harmonious. The plurality of audio signals may be identified 106 according to the user preference. The ordered audio signals may be outputted 112.

1. A method for ordering a plurality of audio signals into a sequence comprising:
receiving (104) a user preference;
analysing (108) the plurality of audio signals to extract inherent features; and
ordering (110), independently of user involvement, into a sequence at least two audio signals of the plurality of audio signals based on a comparison of the extracted features and user preference such that adjacent signals in the sequence are harmonious.

2. A method as claimed in claim 1 wherein the plurality of audio signals is identified (106) according to the user preference.

3. A method as claimed in claim 1 or 2, wherein the extracted inherent features are musical features.

4. A method as claimed in claim 3, wherein adjacent audio signals in the sequence have related musical keys.

5. A method as claimed in claim 4, wherein the related musical keys (200) are determined according to the Equal Tempered Scale.

6. A method as claimed in any preceding claim and further comprising outputting (112) the at least two audio signals according to the sequence.

7. A method as claimed in claim 6, wherein a currently output signal (302) is crossfaded with the immediately succeeding signal (304) in the sequence so as to present a continuous outputting.

8. A method as claimed in claim 7, wherein the crossfading is dependent on the respective bass note amplitudes of the current signal and the immediately succeeding signal in the sequence.

9. A method as claimed in claim 8, wherein during the time interval of the crossfade the bass note amplitude of each audio signal is less than one seventh of the maximum bass amplitude of the respective audio signal.

10. A system for ordering a plurality of audio signals into a sequence comprising:
a receiving device (406) operable to receive a user preference;
a store (408) operable to store audio signals;
a data processor (400) operable to:
analyse the plurality of audio signals to extract inherent features; and
order, independently of user involvement, into a sequence at least two audio signals of the plurality of audio signals based on a comparison of the extracted features and user preference such that adjacent signals in the sequence are harmonious.

11. A system as claimed in claim 10 wherein the data processor (400) is operable to identify the plurality of audio signals according to the user preference.

12. A system as claimed in claim 10 or 11 and further comprising an audio input device (402) operable to receive audio signals, the data processor (400) operable to store the received audio signals.

13. A system as claimed in any of claims 10 to 12 and further comprising an output device (404) operable to output the at least two audio signals of the plurality of audio signals according to the sequence, the data processor (400) operable to control said output device.

14. A system as claimed in claim 13, wherein the output device is operable to crossfade a currently output signal with the immediately succeeding signal in the sequence.

15. A record carrier comprising software operable to carry out the method of any of claims 1 to 9.

16. A software utility configured for carrying out the method steps as claimed in any of claims 1 to 9.

17. A system including a data processor, said data processor being directed in its operations by a software utility as claimed in claim 16.
